(19) United States
(12) Patent Application Publication
(10) Pub. No.: US 2025/0089602 A1
(43) Pub. Date: Mar. 20, 2025

(54) Agricultural Implement and Method of Operating Agricultural Implement

(71) Applicant: Väderstad Holding AB, Väderstad (SE)

(72) Inventors: Lars Thylén, Linköping (SE); Jörgen Dahl, Ödeshög (SE)

(21) Appl. No.: 18/580,330

(22) PCT Filed: Jul. 21, 2022
(86) PCT No.: PCT/EP2022/070445

§ 371 Date: Jan. 18, 2024

(30) Foreign Application Priority Data
Jul. 21, 2021 (SE) 2150964-1

(51) Int. Cl. A01C 5/06; A01C 7/20

(52) U.S. Cl. CPC A01C 5/068; A01C 7/203; A01C 7/205

(57) ABSTRACT

An agricultural implement (1) for distribution of granular material to ground over which the agricultural implement travels comprises a plurality of output units (20), each comprising a unit frame (21), a material outlet (262) and at least one ground engaging member (22), a plurality of packer units (30), each packer unit being laterally aligned with and positioned in front of, as seen in a working direction, one of the output units (20). Each packer unit (30) comprises a base (31), an arm (32), which is movably connected to the base (31), a force element (34) operable between the base and the arm (32), so as to influence a relative position of the arm and the base (31), and a packer wheel (33), rotatably supported by the arm (32), said packer wheel (33) having an effective width corresponding to that of the output unit (20). There is also disclosed a method of operating an agricultural implement.

### TECHNICAL FIELD

The present disclosure relates to a packer device for use in an agricultural implement, such as a planter or a seeder, to an agricultural implement comprising such packer device and to a method of operating an agricultural implement.

### BACKGROUND

In a field that has been tilled, it is known to reconsolidate soil surface prior to planting. Such reconsolidation is typically performed using some sort of packer roller. Implements carrying one or more packer rollers are known. Each roller section is typically 1-3 m wide.

However, as a consequence of height variations in the field, which may have arisen through the tillage and/or through the pressure of wheels of implements that have travelled over the field, such reconsolidation is bound to be uneven over the width of the packer roller.

Another cause of uneven packing is the fact that the wheels of the traction vehicle carrying or towing the planter or seeder will provide wheel tracks, as will any support wheels of the planter or seeder.

It is known that small differences in packing may have significant effect on the germination of the crops.

Hence, there is a need for an improved way of addressing the reconsolidation achieved by agricultural implements.

### SUMMARY

It is an object of the present disclosure to provide an agricultural implement and method, which can provide enhanced precision in the placement of granular material, such as seeds.

The invention is defined by the appended independent claims. Embodiments are set forth in the appended dependent claims, in the following description and in the attached drawings.

According to a first aspect, there is provided an agricultural implement for distribution of granular material to ground over which the agricultural implement travels. The agricultural implement comprises a plurality of output units, each comprising a unit frame, a material outlet and at least one ground engaging member and a plurality of packer units, each packer unit being laterally aligned with and positioned in front of, as seen in a working direction, one of the output units. Each packer unit comprises a base, an arm, which is movably connected to the base, a force element operable between the base and the arm, so as to influence a relative position of the arm and the base, and a packer wheel, rotatably supported by the arm, said packer wheel having an effective width corresponding to that of the output unit.

By providing a packer unit in front of the output unit, it is possible to enhance the operation of the output unit, as it may work more effectively in already packed soil.

By providing a packer unit having a packer wheel with a width that corresponds to that of a single crop row, it is possible to allow the packer wheel to move individually for each crop row, such that the reconsolidation may be the same, or at least more even, across the width of the agricultural implement.

The term “effective width” means that the operating width of the packer unit may be approximately the same as that of the output unit. For example, a packer wheel width may be the same+/−20% as that of a total width of the gauge wheel assembly (which may comprise a pair of wheels that have approximately the same axis of rotation).

Moreover, the need for support wheels to be used field operation is reduced or eliminated.

The force element may be a spring, such as a gas spring or a helical spring, configured to bias the arm relative to the base.

Alternatively, the force element may be a ground height actuator, configured to control the relative position of the arm and the base.

The ground height actuator may be a hydraulic, electric or pneumatic actuator.

A ground force actuator may be configured for controlling a ground force of the output unit.

The agricultural implement may further comprise a controller, which is configured to control said actuator(s).

The controller may be configured to control at least one of the ground height actuator and the ground force actuator so as to keep the agricultural implement parallel with ground which it traverses, such as horizontal. In particular, the ground height actuator and the ground force actuator may be controlled to maintain the agricultural implement horizontal as seen in a vertical plane comprising the working direction.

The agricultural implement may further comprise a ground height sensor, wherein the controller is configured to receive a ground height signal from the ground height sensor and control at least one of the ground height actuator and the ground force actuator based on the ground height signal.

In the agricultural implement, at least two ground height sensors may be positioned laterally spaced apart on the agricultural implement, and the controller may be configured to control at least one of the ground height actuator and the ground force actuator based on signals from said at least two ground height sensors.

Each output unit may be provided with a respective ground force actuator for controlling the ground force of that output unit.

The ground force actuators may be controllable as a single circuit covering an entire width of the agricultural implement, as at least two separate group circuits, each covering a part of the width of the agricultural implement, or each individually.

The actuators forming part of a group will typically be connected in parallel, such that the same pressure is provided on all of the actuators in that group.

The ground height actuators may be controllable as a single circuit covering an entire width of the agricultural implement, as at least two separate group circuits, each covering a part of the width of the agricultural implement, or each individually.

In particular, the ground force actuators may be individually controllable, and the ground height actuators may be controllable as at least one group, in particular one group per frame section of the agricultural implement.

Alternatively, the ground force actuators may be individually controllable, and the ground height actuators may be controllable as at least one group, preferably 2-4 groups.

The controller may be configured to control the ground force actuators to maintain a predetermined pressure and the controller may be configured to control the ground height actuator or actuators to maintain a predetermined ground height.

For example, as the machine becomes lighter, due to the amount of material in the container being reduced, the pressure on the ground height actuators may be reduced, so as to shift pressure onto the output units.

According to a second aspect, there is provided a method of operating an agricultural implement for distribution of granular material to ground over which the agricultural implement travels, wherein the agricultural implement comprises a plurality of output units, each comprising a unit frame, a material outlet and at least one ground engaging member. The method comprises providing a packer unit comprising a packer wheel to engage the ground in front of each of the output units, wherein each packer unit comprises a base, an arm, which is movably connected to the base, a force element operable between the base and the arm, so as to control a relative position of the arm and the base, and a packer wheel, rotatably supported by the arm, said packer wheel having an effective width corresponding to that of the output unit, and causing each of the packer units to operate in a same strip as one of the output units, such that each output unit operates on pre-packed soil.

The method may further comprise providing a ground force actuator for controlling a ground force of each of the output units, providing the force element in the form of a ground height actuator, controlling the ground force actuator to provide a predetermined ground force for each of the output units, and controlling the ground height actuator to provide a predetermined ground height for the packer unit.

The method may further comprise measuring at least distance to ground for the agricultural implement and controlling the ground height actuator based on said distance.

The method may further comprise controlling each ground force actuator individually, and controlling at least two of the ground height actuators as a group.

The method may further comprise, during field operation of the agricultural implement, operating the force element, in the form of an actuator, so as to change a load ratio between the packer units and the output units such that a greater portion of the load is carried by the output units, in particular shifting the load ratio successively during said field operation, and in particular in relation to a reduction of an amount of material carried in a material container.

The total machine weight is distributed over a plurality of packer units and associated output units. Hence, each pair of associated packer unit and output unit will carry a portion of the machine weight. Within each such pair, the weight portion is carried partially by the packer unit and partially by the output unit. The term “load ratio” between the packer units and the output units is thus the relationship of how much of the portion of the machine weight is carried by the packer unit in relation to how much of the portion of the machine weight is carried by the output unit.

The ground force actuator and the ground height actuator may be controlled so as to keep the output unit in an orientation that is parallel with ground that is traversed by the agricultural implement.

The weight of the agricultural implement is carried substantially by the packer units and by the output units.

The term “carried substantially” implies that the entire weight is carried by the packer units and by the output unit, except for any portion of the weight that is carried by the connection to a traction vehicle, such as a tow hook or a tractor hitch.

### BRIEF DESCRIPTION OF THE DRAWINGS

FIG. 1 is a perspective view obliquely from behind, which schematically illustrates an agricultural implement in the form of a seeder.

FIG. 2 is a side view of the seeder in FIG. 1.

FIG. 3 is a view from below of the seeder in FIGS. 1-2.

FIG. 4 is a detail side view of an output unit.

### DETAILED DESCRIPTION

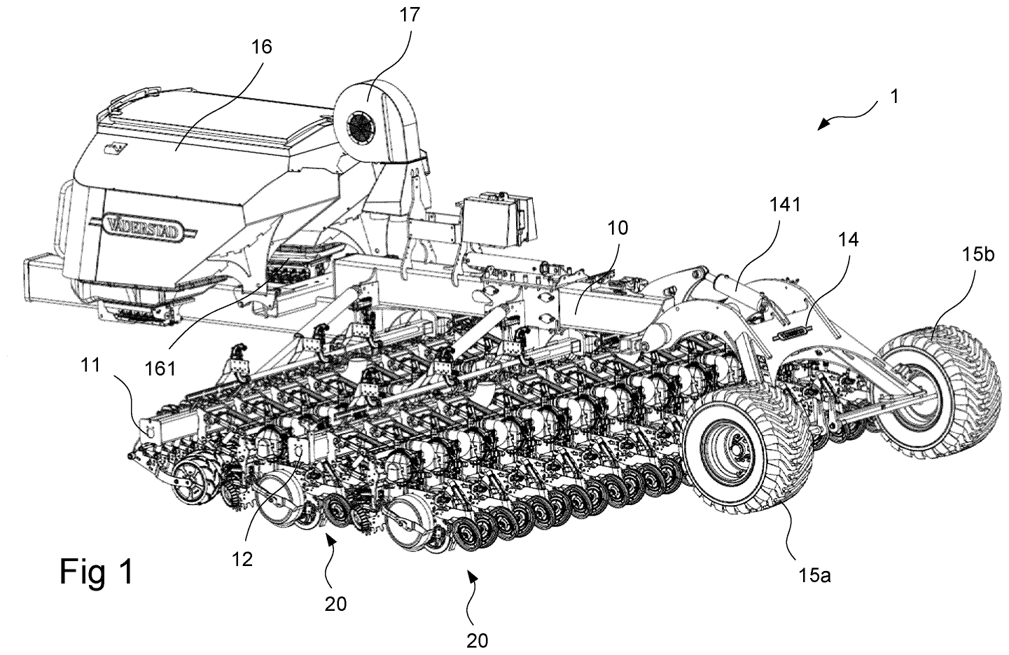

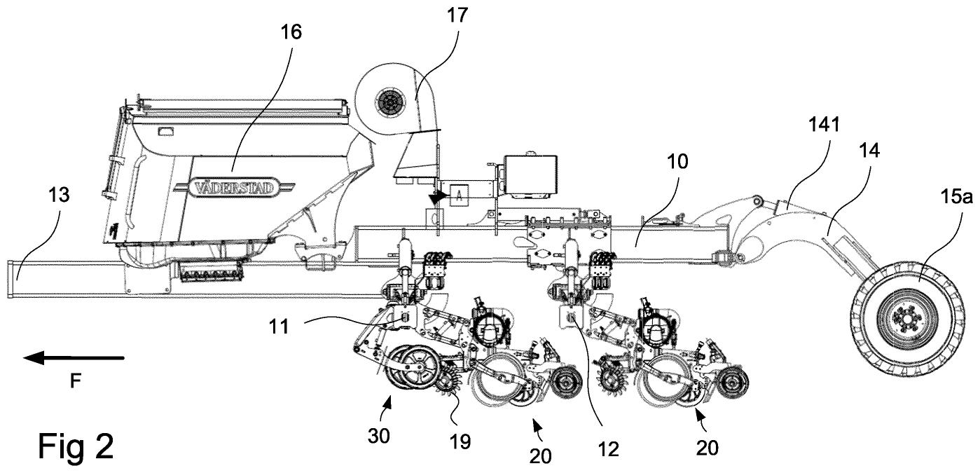

Referring to FIGS. 1 and 2, there is schematically illustrated an agricultural implement in the form of a planter.

While the principle of the present inventive concept is disclosed with reference to a planter, it is understood that the inventive concept may equally be used for a seeder type agricultural implement.

The agricultural implement 1 comprises a main frame 10, which may comprise a longitudinally extending portion and one or more transversely extending portions 11, 12, such as beams.

The transversely extending portions 11, 12 may be formed as a single section, e.g. for a narrower implement, or they may be divided into two or more side sections or outriggers, for a wider implement. For example, the transversely extending portion 11, 12 may be divided into 2, 3, 4 or 5 portions, which may be pivotably arranged relative to each other so as to enable folding of the implement between a working state, wherein the implement may be extended to its maximum width, and a transport state, wherein the implement may be folded to its narrowest width.

A front portion 13 of the main frame may be provided with a drawbar or other arrangement for connection to a traction vehicle (not shown).

In the illustrated embodiment, the frame further comprises a rear frame 14, which may be pivotably connected to the main frame 10. The rear frame 14 may carry one or more transport wheels 15a, 15b. The rear frame 14 may be pivotably connected to the main frame 10, such that the transport wheels 15a, 15b may be lowered to a transportation position and raised to a working position, wherein the transport wheels need not contact the ground.

An actuator 141 may be operable between the main frame 10 and the rear frame 14 for controlling the relative position of the main frame 10 and the rear frame 14.

The agricultural implement 1 may further present at least one container 16 for material to be distributed by the implement.

The agricultural implement 1 may further present at least one source of pressurized air, such as a fan, 17, which may be connectable via a primary channel 171 to a feeder 161, for feeding material from the container to the primary channel to provide a material laden airflow. The material-laden airflow may be guided by secondary channels (not shown), e.g. in the form of flexible hoses, for distributing the material-laden airflow to a plurality of output units 20, which may be provided in the form of row units.

Along at least one of the transversely extending sections 11, 12, a plurality of such output units 20 are provided. In the illustrated example, the output units are identical.

Also along at least one of the transversely extending sections 11, 12, a plurality of packer units 30 are provided.

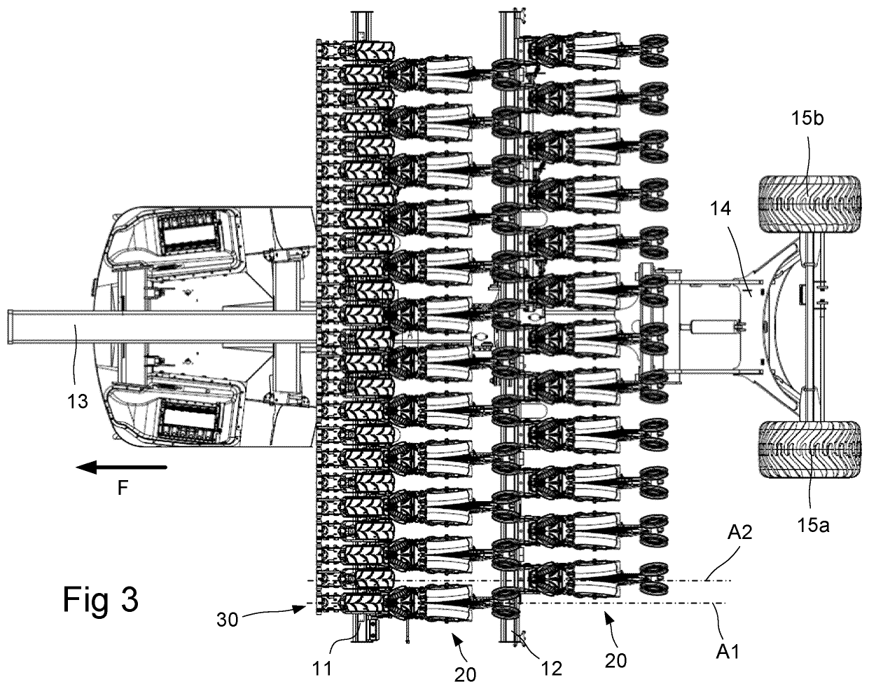

Referring to FIG. 3, each packer unit 30 is aligned with one of the output units 20 along a line A1, A2 extending in parallel with the working direction F.

In the illustrated example, all packer units 30 are arranged side by side on a forward one of the transversely extending sections 11, 12, while the output units 20 are distributed over the forward and rearward transversely extending sections 11, 12. In such an arrangement, the output units 20 arranged on the rearward one of the transversely extending sections 11, 12 may be laterally offset relative to the output units arranged on the forward one of the transversely extending sections 11, 12, such that each one of the packer units 30 is followed by only one of the output units 20.

In other embodiments, all packer units 30 and all output units 20 may be arranged on the same transversely extending section 11, 12.

In yet further embodiments, each packer unit 30 and its aligned output unit 20 may be arranged on the same transversely extending section 11, 12, e.g. such that half of the packer units 30 and output units 20 are arranged on the front transversely extending section 11 and half of the packer units 30 and output units 20 are arranged on the rear transversely extending section 12 and laterally offset relative to the ones on the front transversely extending section 11.

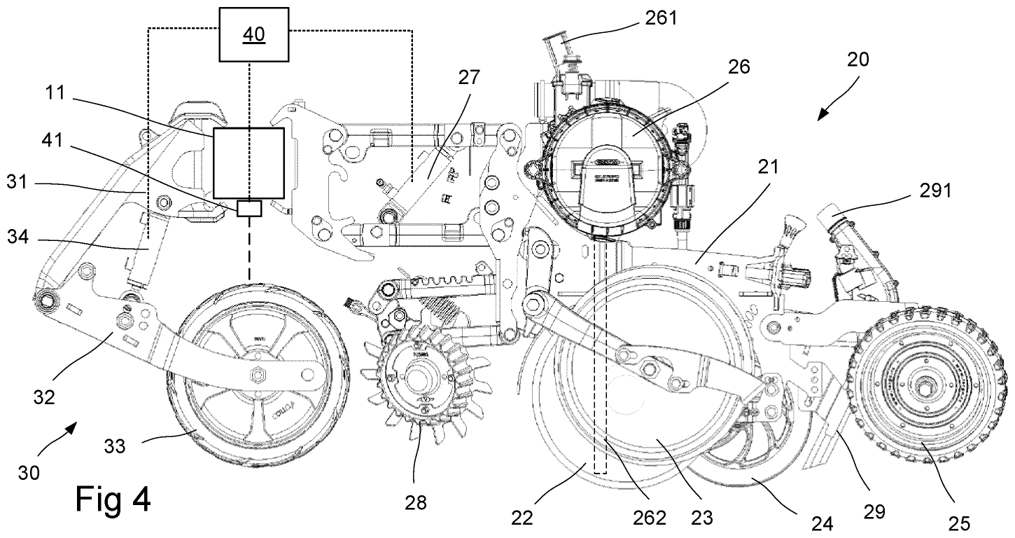

Referring to FIG. 4, each output unit 20 may comprise a unit frame 21, which may be movably connected to the transversely extending section 11, 12 in a manner known per se. In the illustrated example, the unit frame 21 is connected to the transversely extending section 11, 12 through a parallel linkage mechanism with an actuator 27 for controlling a ground force provided by the output unit 20.

The output unit 20 may further comprise a furrow opener 22 and at least one gauge wheel 23, the relative positions of which may be adjustable. A material outlet (262) may have the form of a tube, a hose or a seed knife, which may be positioned such that it is protected by the furrow opener 22. The furrow opener may comprise a pair of discs which are arranged in a V-formation.

The output unit 20 may further comprise a press wheel 24, for pressing the dispensed material into contact with the ground and a closing device 25 for closing the furrow opened by the furrow opener 22.

The secondary channels (not shown) may feed material to a singulating device 26, in particular a high pressure type signulating device, from which the material may be fed in a controlled manner to the material outlet. The singulating device 26 receives material from the secondary channels (not shown) at an inlet 261.

Optionally, further tools may be provided on each output unit 20. In the illustrated example, a cleaner device 28 is arranged upstream of the furrow opener and an auxiliary dispensing device 29 is provided downstream of the press wheel 24 and upstream of the closing device 25, for dispensing one or more additional products. The auxiliary dispensing device may receive material at an inlet 291 from another central container and feeder assembly. The auxiliary material may comprise grass leys, small-seeded crops, cover crops, slug pellets or micro granules.

The packer unit 30 may comprise a base 31, which may be connectable to, or integrated with, the transversely extending section 11, 12; an arm 32, which is movably, such as pivotably, connected to the base 31, such that a free portion of the arm 32 is height adjustable relative to the base 31 and carries a packer wheel 33. A second actuator 34 may be operable between the base 31 and the arm 32, so as to control a relative position of the arm 32 and the base 31.

As an alternative to the second actuator, there may instead be used a biasing device, such as a spring, in particular a gas spring or a helical spring.

A controller 40, which may form part of a common controller for the agricultural implement 1, or of a common controller provided in the traction vehicle, may be configured for controlling the first and second actuators 27, 34.

A ground height sensor 41 may be provided for measuring a ground height of the frame. Such ground height sensor 41 may be arranged to measure the height between the frame and the ground or between the frame and e.g. a packer wheel 33, based on which the ground height can be derived.

Each frame section may be provided with at least one such ground height sensor 41. However, at least two laterally spaced apart ground height sensors 41 is preferred, as this would enable an average ground height to be derived.

The controller 40 may be configured for controlling the first actuators 27 so as to provide a predetermined ground force at each output unit 20.

To this end, in some embodiments, all of the output units 20 may be controlled as a single circuit.

In other embodiments, the output units 20 may be divided into a plurality of groups of adjacent output units 20, whereby each such group is controlled as a single circuit. For example, with a machine comprising two or more side sections, the output units of each such side section may be controlled as one circuit.

In yet other embodiments, each output unit 20 may be individually controlled.

The controller 40 may further be configured for controlling the second actuators 34 to maintain a predetermined frame height. In particular, the controller 40 may be configured to control the second actuators 34 so as to maintain the output unit 20 in a predetermined orientation relative to the ground, in particular such that the output unit 20 will always be oriented parallel with the ground as seen in the longitudinal direction.

To this end, in some embodiments, all of the packer units 30 may be controlled as a single circuit.

In other embodiments, the packer units 30 may be divided into a plurality of groups of adjacent packer units 30, whereby each such group is controlled as a single circuit. For example, with a machine comprising two or more side sections, the packer units of each such side section may be controlled as one circuit.

In yet other embodiments, each packer unit 30 may be individually controlled.

As mentioned, the concept described above may be applied also to an agricultural device of a seeder type, where the granular material would typically be fed by means of a material-carrying airflow through one or a fed primary channels to a respective distributor, from which the material would be distributed to a plurality of output units, which may be of various types.

The present concept is particularly useful for planters and seeders where the ground force of the output unit is controllable.

1-20. (canceled)

21. An agricultural implement for distribution of granular material to ground over which the agricultural implement travels, comprising:
a plurality of output units, each comprising a unit frame, a material outlet and at least one ground engaging member, such as a furrow opener,
wherein a ground force actuator is configured for controlling a ground force of the output unit,
a plurality of packer units, each packer unit being laterally aligned with and positioned in front of, as seen in a working direction, one of the output units,
wherein each packer unit comprises:
a base,
an arm, which is movably connected to the base,
a force element operable between the base and the arm, so as to influence a relative position of the arm and the base,
a packer wheel, rotatably supported by the arm, said packer wheel having an effective width corresponding to that of the output unit,
a controller, which is configured to control said actuator(s), and
a ground height sensor, wherein the controller is configured to receive a ground height signal from the ground height sensor and control the ground height actuator based on the ground height signal,
wherein the force element is a ground height actuator, configured to control the relative position of the arm and the base.

22. The agricultural implement as claimed in claim 21, wherein at least two ground height sensors are positioned laterally spaced apart on the agricultural implement, and wherein the controller is configured to control at least one of the ground height actuator and the ground force actuator based on signals from said at least two ground height sensors.

23. The agricultural implement as claimed in claim 21, wherein each output unit is provided with a respective ground force actuator for controlling the ground force of that output unit.

24. The agricultural implement as claimed in claim 23, wherein the ground force actuators are controllable:
as a single circuit covering an entire width of the agricultural implement,
as at least two separate group circuits, each covering a part of the width of the agricultural implement, or
each individually.

25. The agricultural implement as claimed in claim 23, wherein the ground height actuators are controllable:
as a single circuit covering an entire width of the agricultural implement,
as at least two separate group circuits, each covering a part of the width of the agricultural implement, or
each individually.

26. The agricultural implement as claimed in claim 23, wherein
the ground force actuators are individually controllable, and
the ground height actuators are controllable as at least one group, in particular one group per frame section of the agricultural implement.

27. The agricultural implement as claimed in claim 23, wherein
the ground force actuators are individually controllable, and
the ground height actuators are controllable as at least one group, preferably 2-4 groups.

28. The agricultural implement as claimed in claim 21, wherein the controller is configured to control the ground force actuators to maintain a predetermined pressure and wherein the controller is configured to control the ground height actuator or actuators to maintain a predetermined ground height.

29. A method of operating an agricultural implement for distribution of granular material to ground over which the agricultural implement travels,
wherein the agricultural implement comprises a plurality of output units, each comprising a unit frame, a material outlet and at least one ground engaging member, such as a furrow opener,
the method comprising:
providing packer units to engage the ground in front of each of the output units,
wherein each packer unit comprises a base, an arm, which is movably connected to the base, a force element operable between the base and the arm, so as to control a relative position of the arm and the base, and a packer wheel, rotatably supported by the arm, said packer wheel having an effective width corresponding to that of the output unit,
causing each of the packer units to operate in a same strip as one of the output units, such that each output unit operates on pre-packed soil
providing a ground force actuator for controlling a ground force of each of the output units,
providing the force element in the form of a ground height actuator,
controlling the ground force actuator to provide a predetermined ground force for each of the output units,
controlling the ground height actuator to provide a predetermined ground height for the packer unit, and
measuring at least distance to ground for the agricultural implement and controlling the ground height actuator based on said distance.

30. The method as claimed in claim 29, further comprising controlling each ground force actuator individually, and controlling at least two of the ground height actuators as a group.

31. The method as claimed in claim 29, further comprising, during field operation of the agricultural implement, operating the force element, in the form of an actuator, so as to change a load ratio between the packer units and the output units such that a greater portion of the load is carried by the output units, in particular shifting the load ratio successively during said field operation, and in particular in relation to a reduction of an amount of material carried in a material container.

32. The method as claimed in claim 29, wherein the ground force actuator and the ground height actuator are controlled so as to keep the output unit in an orientation that is parallel with ground that is traversed by the agricultural implement.

33. The method as claimed in claim 29, wherein the weight of the agricultural implement is carried substantially by the packer units and by the output units.
